(19) United States
(12) Patent Application Publication
(10) Pub. No.: US 2024/0151813 A1
(43) Pub. Date: May 9, 2024

(54) Method for Checking a Functional Capability of a Distance Sensor of a Vehicle During Operation of the Vehicle, and Computing Device

(71) Applicant: Bayerische Motoren Werke Aktiengesellschaft, Muenchen (DE)

(72) Inventor: Jonathan FISCHER, Huettlingen (DE)

(21) Appl. No.: 18/280,006

(22) PCT Filed: Feb. 25, 2022
(86) PCT No.: PCT/EP2022/054770

§ 371 Date: Sep. 1, 2023

(30) Foreign Application Priority Data
Mar. 5, 2021 (DE) 10 2021 105 344.7

(51) Int. Cl. G01S 7/40; G01S 13/08; G01S 13/931; G01S 7/497; G01S 17/08; G01S 17/931

(52) U.S. Cl. CPC G01S 7/4039; G01S 13/08; G01S 13/931; G01S 2007/4975; G01S 17/08; G01S 17/931

(57) ABSTRACT

A method for checking a functional capability of a distance sensor of a vehicle includes continuously receiving sensor data from the distance sensor, wherein the sensor data describe a sensor signal emitted by the distance sensor and reflected on at least one object in an environment of the vehicle; continuously determining distance values, which describe a distance between the distance sensor and the at least one object, on the basis of the sensor data; storing the distance values for a predetermined period of time; determining a current range of the distance sensor on the basis of the stored distance values; comparing the current range with a predetermined maximum range of the distance sensor; and checking the functional capability of the distance sensor on the basis of the comparison.

### BACKGROUND AND SUMMARY OF THE INVENTION

The present invention relates to a method for checking a functional capability of a distance sensor of a vehicle. In addition, the present invention relates to a computing device and a computer-readable storage medium.

Modern vehicles normally comprise corresponding distance sensors, such as, for example, radar sensors or lidar sensors. These distance sensors can be part of a driver assistance system of the vehicle. Objects in the environment of the vehicle can be detected with these distance sensors and the position of the objects relative to the vehicle can be determined. Reliable operation of these distance sensors is essential for the function of driver assistance systems with which, for example, an automated or autonomous driving of the vehicle is enabled.

The distance sensors have a maximum range according to the specification. This maximum range is, on one hand, determined by digital limits, i.e., for example, the cutting off of signals at a maximum distance. In addition, this maximum range is determined by the sensitivity of the distance sensor itself. The sensitivity of the distance sensor describes the ability to distinguish even weak signals from background noise. The maximum range of the distance sensors is variable due to ageing, contamination and/or other environmental influences on the distance sensor and its environment. Knowledge of the current range of the distance sensor during driving operation or during operation of the vehicle is safety-relevant. If, for example, no object or obstacle can be detected with the distance sensor at a distance of 200 m, this can mean, on one hand, that no real object is actually present there. On the other hand, however, it may be the case that the current maximum range of the distance sensor is less than 200 m and therefore an object that is present cannot therefore be detected.

According to the prior art, the distance sensors are designed for the necessary maximum range, including a reserve. This reserve is then, in a manner of speaking, “consumed” by all influences which reduce the maximum range of the distance sensor during normal driving operation. Identified objects are assigned a confidence value of existence, derived from the signal-to-noise ratio for the object concerned, wherein, in this case, the history is also incorporated.

In addition, it is known from the prior art that controlled conditions and a known, artificially placed reference target are provided for measuring or determining the maximum range of the distance sensor. However, controlled conditions of this type are not present during normal driving operation. In addition, reference targets of this type are not present during operation of the vehicle. For oncoming objects, it is therefore not possible to guarantee that the theoretically present maximum range is currently available.

In this context, DE 10 2018 217 173 A1 describes a reflector system in a radar target simulator for testing a functional capability of a radar sensor. The reflector system comprises at least one antenna for emitting an electromagnetic wave in a transmit plane for simulating a backscatter of an obstacle, and also a reflector for reflecting an electromagnetic wave emitted by the at least one antenna into a receive plane.

The object of the present invention is to indicate a solution whereby the functional capability of a distance sensor of a vehicle can be checked during operation of the vehicle.

This object is achieved according to the invention by a method, by a computing device, by a computer program and by a computer-readable storage medium with the features according to the claims.

A method according to embodiments of the invention serves to check a functional capability of a distance sensor of a vehicle. The method comprises continuously receiving sensor data from the distance sensor, wherein the sensor data describe a sensor signal emitted by the distance sensor and reflected on at least one object in an environment of the vehicle. The method further comprises continuously determining distance values which describe a distance between the distance sensor and the at least one object, on the basis of the sensor data. The method further comprises storing the distance values for a predetermined period of time. The method further comprises determining a current range of the distance sensor on the basis of the stored distance values, and comparing the current range with a predetermined maximum range of the distance sensor. In addition, the method comprises checking the functional capability of the distance sensor on the basis of the comparison.

The functional capability of the distance sensor is intended to be checked by way of the method. In particular, the current range of the distance sensor can be determined by way of the method. The method can preferably be carried out during operation of the vehicle or during the driving of the vehicle. The method can be carried out with a corresponding computing device of the vehicle or of a sensor system of the vehicle. This competing device can, for example, be an electronic control unit of the vehicle. The distance sensor can preferably be designed as a radar sensor or as a lidar sensor.

Sensor data of the distance sensor can be received continuously during operation of the vehicle. These sensor data can be transmitted from the distance sensor to the computing device. These sensor data describe a sensor signal which has been emitted by the distance sensor and has been reflected on the at least one object in the environment of the vehicle. The sensor signal can, for example, be an electromagnetic wave, optical radiation or the like. The distance values which describe the distance between the distance sensors and the at least one object can then be determined on the basis of these received sensor data. The distance values can then be determined on the basis of the delay between the emission of the sensor signal and the reception of the sensor signal reflected by the at least one object. These distance values can be stored or saved in a ring memory for the predetermined period of time, which can, for example, amount to between a few minutes and a few hours.

The current range of the sensor can then be determined on the basis of the stored distance values. On the basis of the stored distance values, it is therefore possible to determine the distance up to which objects can still be detected. The current range describes, in particular, a maximum distance at which objects can currently be detected or recorded with the distance sensor. This current range of the distance sensor can therefore be at least estimated on the basis of the stored distance values. The current range or the estimated range of the distance sensor can then be compared with the predetermined maximum range. This maximum range can be predefined by a manufacturer of the distance sensor or can be obtained from a datasheet of the distance sensor.

The functional capability of the distance sensor can then be determined on the basis of the comparison of the current range of the distance sensor, which has been determined during operation of the vehicle, and the predefined maximum range. In particular, it is possible to determine here whether the current range of the sensor corresponds to the predefined minimum range or whether the difference between the estimated current range and the maximum range lies within a predefined interval. According to embodiments of the present invention, the objects in the environment or the other road users are used as sounders. This enables the current range of the distance sensor to be estimated during operation of the vehicle. Thus, for example, no separate reference targets or controlled conditions are required in order to be able to determine the range of the distance sensor. The range of the distance sensor can be determined during operation of the vehicle, and furthermore also continuously.

A plurality of distance segments are preferably predefined, a check is carried out on the basis of the distance values to identify the distance segments in which the at least one object is or has been detected by way of the distance sensor, and the current range of the distance sensor is determined on the basis of the distance segments in which the at least one object is or has been detected. A plurality of distance segments can be predefined in the detection area of the distance sensor. The detection area of the distance sensor is to be understood to mean the area in the environment in which objects can be detected with the distance sensor. These distance segments can describe different distances or distance values in relation to the distance sensor. On the basis of the distance values which describe the distances to the objects in the environment and which are detected continuously, a check can then be carried out to identify the distance segments in which objects have already been detected. At the start of the method, the respective distance segments can be set, for example, to the value 0 or “no” or “not reached”. As soon as an object has been detected in one of the distance segments, the value 1 or “yes” or “reached” can be assigned to this distance segment. The current range of the distance sensor can be determined in this way with little computing effort.

In a further embodiment, a plurality of angle segments are predefined and a check is further carried out on the basis of the distance values to identify the angle segments in which the at least one object is or has been detected by way of the distance sensor. The angle segments can therefore also be predefined in addition to the distance segments. These angle segments can also be predefined in the detection area of the distance sensor. The angle segments can, for example, be assigned in each case to an angle segment in the azimuthal direction. Similar to the distance segments, recordings can also be made for the individual angle segments which describe whether an object has already been detected in this angle segment. It is therefore possible to detect, with little computing effort, whether the functional capability for the distance sensor is restricted in some areas or for an angle range.

It is provided here, in particular, that a blocking of the distance sensor is detected on the basis of the angle segments in which the at least one object is or has been detected. The term “blocking” is to be understood here to mean that the distance sensor is obscured or contaminated in some areas. Contamination, ice, snow or a different object can be disposed on the distance sensor at least in some areas. If, for example, it is recognized that no object has yet been detected in one of the angle segments, whereas objects have already been detected in the other angle segments, it can be concluded that an area of the distance sensor is blocked or contaminated. Contamination, ice, snow, a label or the like can be located, for example, on the distance sensor or on a cover of the distance sensor. A blocking of this type can be detected by checking the angle segments and the driver can be prompted if necessary to check a corresponding blocking or contamination of the distance sensor.

It can further be provided that a blocking or contamination of the distance sensor is detected separately from the examination of the angle segments. The distance sensor itself, for example, can detect a corresponding blocking. This blocking can be detected separately, for example, on the basis of the sensor signal reflected on the contamination and/or on the basis of the obstruction to the emission of the sensor signal due to the contamination. A separately detected blocking of this type can then be verified on the basis of the examination of the angle segments.

In a further embodiment, the current range of the distance sensor is determined on the basis of the distance values which describe objects moving away from the vehicle. Objects, in particular, which move away or distance themselves from the vehicle are therefore suitable for estimating the current range of the distance sensor. Objects of this type can be reliably detected, for example, within a short distance to the distance sensor. If these objects then move away from the distance sensor, it is possible to check the distance or distance segment up to which these objects can be tracked. The current range of the distance sensor can be reliably and simply determined in this way.

It is further advantageous if the current range of the distance sensor is determined on the basis of the distance values which describe objects with a predetermined existence probability. It can essentially be provided that objects in respect of which it can also be reliably assumed that these objects are actually located in the environment of the vehicle are used for determining the range of the sensor. In assessing the sensor data which are transmitted from the distance sensor to the computing device, the existence probability or a detection probability can be determined, describing the probability with which a real object is actually involved. The external dimensions of the detected object, in particular, can also be taken into account here. It can be assumed, for example, that objects which have relatively large spatial dimensions can be detected more reliably than small objects. The characteristics of the detected objects can therefore be taken into account. The period of time during which objects of this type can be detected in the environment can additionally be taken into account. A high existence probability or detection probability, for example, can be assigned to objects which are detected for a relatively long period of time.

According to embodiments of the present invention, it is therefore provided that the objects in the environment of the vehicle are used, in a manner of speaking, as “sounders” in order to be able to determine the current range of the distance sensor. Dynamic, i.e. moving, objects, in particular, can be used as objects. However, it can also be provided that static or motionless objects are used. In the method, the vehicle itself can move and/or can be at least partially stationary.

It is further advantageous if the period of time for which the distance values are stored is predetermined on the basis of a traffic situation in the environment of the vehicle. As explained above, the period of time for which the distance values are stored can amount to a few minutes, but also a few seconds. It is provided, in particular, that the period of time is determined on the basis of the environment or the traffic situation in the environment. In an urban traffic situation in which a plurality of other road users or objects are located, the period of time can be chosen as shorter than, for example, in the case of a traffic situation in which the vehicle is located on a rural road in a rural area. The choice of the period of time can be determined in this way as appropriate to the situation or adapted to the environment.

According to a further embodiment, the stored distance values are deleted after the vehicle ignition has been turned on/off. The stored distance values can therefore be deleted when the vehicle is restarted or the ignition is switched on/off. As a result, the determination of the current range of the distance sensor can be restarted after the vehicle has been started or after the vehicle has been shut down. This is suitable, in particular, if the vehicle has been shut down, for example for a lengthy period, for example overnight. In this case, contamination of the distance sensor or damage to the distance sensor may have occurred. A blocking of or damage to the distance sensor can be reliably detected by restarting the method.

A computing device according to embodiments of the invention for a sensor system of a vehicle is configured to carry out a method according to embodiments of the invention and the advantageous embodiments thereof. The computing device can, for example, be an electronic control unit. The sensor system according to embodiments of the invention can have at least one distance sensor in addition to the computing device. This distance sensor can preferably be designed as a radar sensor or as a lidar sensor. The distance sensor can also be designed as a laser scanner, an optical distance sensor, an ultrasound sensor or the like. The sensor system can essentially also have a plurality of different distance sensors.

A vehicle according to embodiments of the invention comprises a sensor system according to embodiments of the invention. The vehicle is preferably designed as a passenger vehicle.

A further aspect of the invention relates to a computer program, comprising commands which, when the program is executed by a computing device, prompt the latter to carry out a method according to embodiments of the invention. The invention further relates to a computer-readable storage medium, comprising commands which, when executed by a computing device from the latter to carry out a method according to embodiments of the invention.

The advantages of the preferred embodiments proposed with reference to the method described herein apply accordingly to the computing device according to embodiments of the invention, to the sensor system according to the invention, to the vehicle according to embodiments of the invention, to the computer program according to embodiments of the invention and to the computer-readable storage medium according to embodiments of the invention.

Further features of the invention are set out in the claims, the figures and the description of the figures. The features and feature combinations set out above in the description, and the features and feature combinations specified below in the description of the figures and/or shown in the figures alone are usable not only in the respectively indicated combination, but also in other combinations or in isolation, without departing the scope of the invention.

The invention will now be explained in detail on the basis of preferred exemplary embodiments and with reference to the attached drawings.

### BRIEF DESCRIPTION OF THE DRAWINGS

FIG. 1 shows a schematic view of a vehicle which has a sensor system with a distance sensor.

FIG. 2 shows a schematic view of a plurality of distance segments and a plurality of angle segments which are predefined in a detection area of the distance sensor.

FIG. 3 shows a schematic flow diagram of a method for checking a functional capability of the distance sensor.

Identical or functionally identical elements are denoted with the same reference symbols in the figures.

### DETAILED DESCRIPTION OF THE DRAWINGS

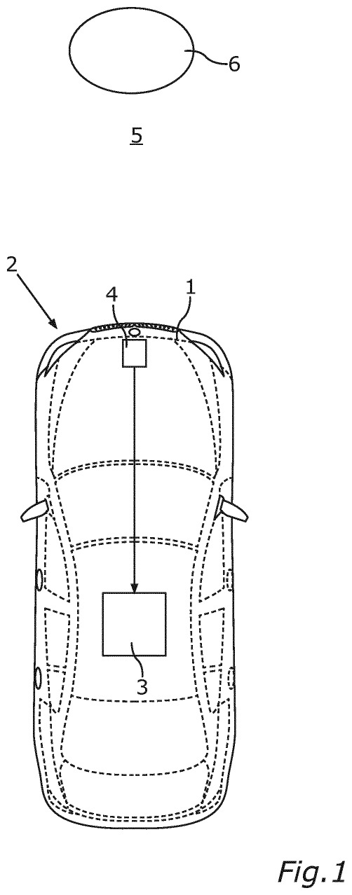

FIG. 1 shows a schematic view of a vehicle 1, which is designed here as a passenger vehicle, in a top view. The vehicle 1 comprises a sensor system 2 which in turn comprises a distance sensor 4. This distance sensor 4 can be designed, for example, as a radar sensor or as a lidar sensor. A sensor signal can be emitted with this distance sensor 4 and the sensor signal reflected on an object 6 in an environment 5 of the vehicle 1 is again received. An object 6 is shown here, by way of example, in the environment 5 of the vehicle 1.

Sensor data which describe this reflected sensor signal can be transmitted from the distance sensor 4 to a computing device 3 of the sensor system 2. This computing device 3 can be formed, for example, by an electronic control unit. Distance values which describe the respective distances between the distance sensor 4 and the objects 6 in the environment 5 can be determined by way of the computing device 3 on the basis of the sensor data. These distance values can be determined on the basis of the delay between the emission and the reception of the sensor signal.

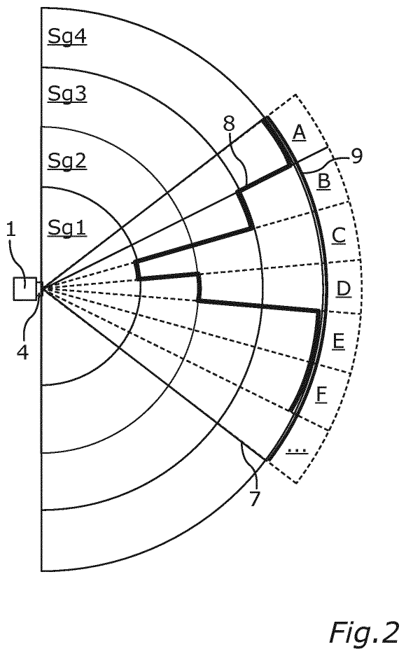

FIG. 2 shows a highly simplified view of the vehicle 1 with the distance sensor 4. A detection area 7 of the distance sensor 4 is further indicated in the environment 5 of the vehicle 1. Objects 6 can be detected with the distance sensor 4 in this detection area 7, which can also be referred to as the field of view of the sensor. A plurality of distance segments Sg1 to Sg4 are further predefined in the environment 5 of the vehicle 1 or in the detection area 7 of the distance sensor 4. A plurality of angle segments A to F are further predefined in the detection area 7. These angle segments A to F can correspond to different angle areas in the azimuthal direction. A check is then carried out on the basis of the distance values to determine whether objects 6 have been detected in each case in the respective distance segments Sg1 to Sg4 and/or in the angle segments A to F.

In the present example, objects 6 have been detected in the angle segment A in all distance segments Sg1 to Sg4. Objects 6 have been detected in the angle segment B in the distance segments Sg1 to Sg3. Objects 6 have been detected in the angle segment C only in the distance segment Sg1. Objects 6 have been detected in the angle segment D in the distance segments Sg1 and Sg2. Objects 6 have been detected in the angle segments E and F in all distance segments Sg1 to Sg4.

The distance segments Sg1 to Sg4 and the angle segments A to F up to which objects 6 have been detected are illustrated here by the line 8. The current range of the distance sensor 4 can be estimated on the basis of these distance segments Sg1 to Sg4 and/or angle segments A to F. The current range can be compared with a predetermined or theoretical maximum range of the distance sensor 4. This is illustrated here by the line 9. The functional capability during operation of the vehicle 1 can thus be estimated by comparing the determined range of the distance sensor 4 with the theoretical maximum range.

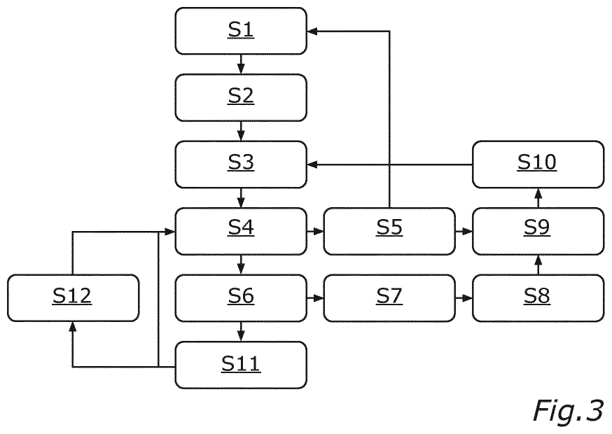

FIG. 3 shows a schematic flow diagram of a method for checking the functional capability of the distance sensor 4. A computer program can be executed on the computing device 3 in order to carry out the method. In a step S1, the vehicle 1 or the sensor system 2 is started. The distance sensor 4 is also activated here or corresponding measurements are carried out with the distance sensor 4. The respective distance values are further determined on the basis of the sensor data of the distance sensor 4. In a step S2, it is defined for the respective distance segments Sg1 to Sg4 and the angle segments A to F that no objects 6 have been detected therein. In a step S3, an object 6 has been detected in an angle segment A to F and in a distance segment Sg1 to Sg4. In a step S4, this angle segment A to F or distance segment Sg1 to Sg4 is indicated as reachable for the distance sensor 4. In addition, after the ignition has been switched on/off, the angle segment A to F and the distance segment Sg1 to Sg4 are marked as not reachable (step S5).

In a step S6, a check is carried out to determine whether a blocking of the distance sensor 4 is detected separately or with the distance sensor 4. In a step S7, a check is carried out on the basis of the angle segments A to F to determine whether this local blocking or contamination of the distance sensor 4 is actually present. In a step S8, the corresponding angle segments A to F and the corresponding distance segments Sg1 to Sg4 are then marked as not reachable. In a step S9, for example, the driver of the vehicle 1 is prompted to free the distance sensor 4 from the blocking or to clean the distance sensor 4. Until then, the corresponding angle segments A to F and the corresponding distance segments Sg1 to Sg4 remain recorded as not reachable (step S10). If no separately identified blocking has been observed in step S6, it is assumed in a step S11 that no blocking or contamination of the distance sensor 4 is present.

Finally, in a step S12, after a selectable time constant or time period, the respective angle segments A to F and the distance segments Sg1 to Sg4, are marked as not reachable. This time period can be chosen in the range between a few minutes up to a few hours. The time period can be predetermined on the basis of the traffic situation in the environment 5 of the vehicle 1 or on the basis of the number of objects 6 in the environment 5. The range of the distance sensor 4 during operation of the vehicle 1 can be estimated by the method and the functional capability of the distance sensor 4 can thus be checked.

1.-10. (canceled)

11. A method for checking a functional capability of a distance sensor of a vehicle, the method comprising:
continuously receiving sensor data from the distance sensor, wherein the sensor data describe a sensor signal emitted by the distance sensor and reflected on at least one object in an environment of the vehicle,
continuously determining distance values which describe a distance between the distance sensor and the at least one object, based on the sensor data,
storing the distance values for a predetermined period of time,
determining a current range of the distance sensor based on the stored distance values,
comparing the current range with a predetermined maximum range of the distance sensor, and
checking the functional capability of the distance sensor based on a result of the comparing.

12. The method according to claim 11, wherein:
a plurality of distance segments are predefined,
a check is carried out based on the distance values to identify a portion of the distance segments in which the at least one object has been detected by way of the distance sensor, and
the current range of the distance sensor is determined based on the portion of the distance segments in which the at least one object has been detected.

13. The method according to claim 11, wherein:
a plurality of angle segments are predefined, and
a check is carried out based on the distance values to identify a portion of the angle segments in which the at least one object has been detected by way of the distance sensor.

14. The method according to claim 13, wherein:
a blocking of the distance sensor is detected based on the portion of the angle segments in which the at least one object has been detected.

15. The method according to claim 11, wherein:
the current range of the distance sensor is determined based on a portion of the distance values which describe objects moving away from the vehicle.

16. The method according to claim 11, wherein:
the current range of the distance sensor is determined based on a portion of the distance values which describe objects with a predetermined existence probability.

17. The method according to claim 11, wherein:
the period of time for which the distance values are stored is predefined based on a traffic situation in the environment of the vehicle.

18. A computing device for a sensor system of a vehicle, wherein the computing device is configured to carry out the method according to claim 11.

19. A computer product comprising a non-transitory computer readable medium having stored thereon program code which, when executed on a computer device, carries out the method according to claim 11.
